(19) United States
(12) Patent Application Publication
(10) Pub. No.: US 2019/0061588 A1
(43) Pub. Date: Feb. 28, 2019

(54) Securable Table Assembly

(71) Applicant: Morris David Smith, Asheboro, NC (US)

(72) Inventor: Morris David Smith, Asheboro, NC (US)

(21) Appl. No.: 16/115,945

(22) Filed: Aug. 29, 2018

Related U.S. Application Data
(60) Provisional application No. 62/551,465, filed on Aug. 29, 2017.

(51) Int. Cl. B60N 3/00; B60N 3/10

(52) U.S. Cl. CPC B60N 3/001; B60N 3/103

(57) ABSTRACT

A securable table assembly to hold food and drinks while driving. The securable table assembly has a plate, having a lower surface and an upper surface, wherein a sidewall extends along an outer perimeter of the upper surface forming an interior volume designed to hold food within. One or more apertures is disposed on the upper surface and designed to receive a beverage container. A rod, having a first end and a second end, is designed to have the first end removably secure to the lower surface of the plate via a fastener. The second end of the rod is designed to secure to a base, having a planar bottom side which is designed to secure flush against a surface, such as a floor, through one or more fasteners. In this way, a user can selectively affix the securable table assembly within a bus.

### CROSS REFERENCE TO RELATED APPLICATIONS

This application claims the benefit of U.S. Provisional Application No. 62/551,465 filed on Aug. 29, 2017. The above identified patent application is herein incorporated by reference in its entirety to provide continuity of disclosure.

### BACKGROUND OF THE INVENTION

The present invention relates to securable table assemblies. More specifically, the present invention comprises a plate having a sidewall extending therearound with one or more apertures disposed therein, configured to secure to a rod which is configured to secure to a base. The base is configured to secure to a planar surface, such as a floor.

Many drivers of large buses, such as RVs, motor homes, and tour buses, require a great deal of concentration while driving. Unfortunately, the drivers are often required to drive for extensive periods of time, and it is difficult for them to eat. Some drivers will stop for food breaks, but this can prolong the trip and frustrate both the drivers and the passengers. Some drivers will store food or snacks in the cockpit of the vehicle, but this requires the driver to search for the food while driving forcing the driver to take their eyes off the road, which is unsafe and can lead to dangerous accidents. Although it is possible for a driver to use a cup holder for a drink, cup holders are often placed in the center of the cockpit and are difficult for a driver to reach. Thus, a securable table assembly that can be selectively placed within the cockpit of the bus and utilized to hold food while additionally providing cup holders for beverages is needed.

### SUMMARY OF THE INVENTION

In view of the foregoing disadvantages inherent in the known types of securable table assemblies now present in the known art, the present invention provides a securable table assembly wherein the same can be utilized for providing convenience for the user when desiring to selectively choose where to assemble a securable table utilized to hold food and provide one or more cup holders for beverages.

The present system comprises a plate, having a lower surface and an upper surface, wherein a sidewall extends along an outer perimeter of the upper surface thereby forming an interior volume with an open upper end. One or more apertures is disposed on the upper surface and configured to receive a beverage container therein. A rod, having a first end and a second end, is configured to have the first end removably secure to the lower surface of the plate via a fastener. The second end of the rod is configured to secure to a base, having a planar bottom side which is configured to secure flush against a surface, such as a floor, through one or more fasteners. In this way, a user can selectively affix the securable table assembly within a bus.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the upper surface of the plate of the securable table assembly.

FIG. 2 shows a perspective view of an embodiment of the lower surface of the plate attaching to the rod.

FIG. 3 shows a perspective view of an embodiment of the rod attaching to the base when the base is attached to a surface.

### DETAILED DESCRIPTION OF THE INVENTION

Reference is made herein to the attached drawings. Like reference numerals are used throughout the drawings to depict like or similar elements of the securable table assembly. The figures are intended for representative purposes only and should not be considered to be limiting in any respect.

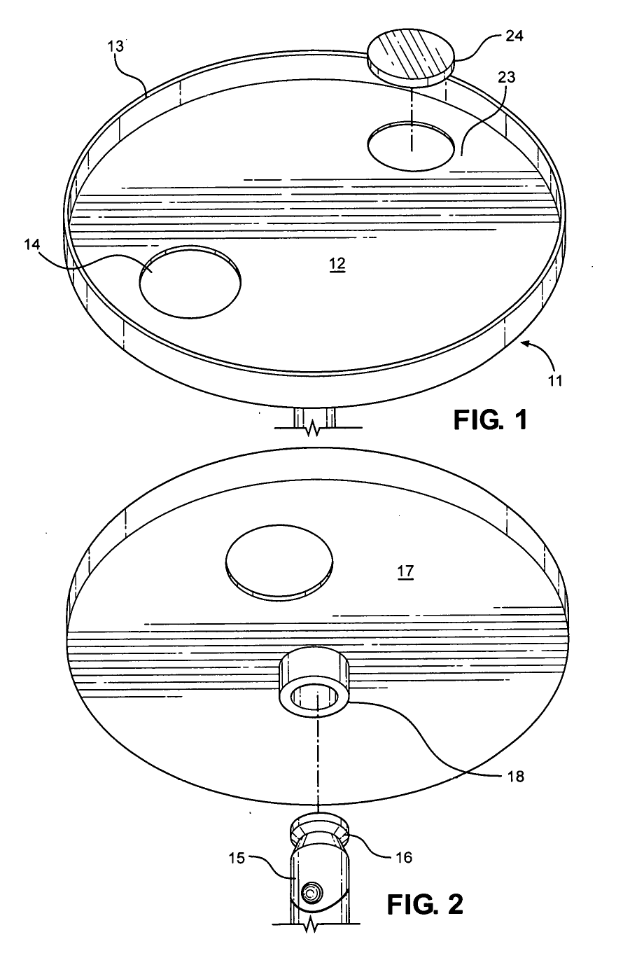

Referring now to FIG. 1, there is shown a perspective view of an embodiment of the upper surface of the plate of the securable table assembly. A securable table assembly comprises a plate 11, having an upper surface 12. A sidewall 13 extends outwardly along an outer perimeter of the upper surface 12, thereby forming an interior volume having an open upper end. In the illustrated embodiment, the upper surface 12 is planar, such that objects placed thereon can rest flush upon the upper surface 12. In the shown embodiment, the plate 11 is annularly shaped. However, in other embodiments, the plate 11 can comprise any planar geometric shape, such as a square or a hexagon.

One or more apertures 14 are disposed on the upper surface 12 of the plate 11, wherein the aperture 14 is configured to receive a beverage container therein. In the illustrated embodiment, the aperture 14 fully extends through the plate 11, such that the bottom end of the beverage container is below the upper surface 12. However, in other embodiments, the aperture 14 comprises an indentation in the upper surface 12, such that the aperture 14 does not fully extend through the plate 11, wherein the indentation is configured to securely receive the beverage container therein. In the shown embodiment, the aperture 14 is disposed near the perimeter of the plate 11, however in other embodiments, the aperture 14 is disposed at a center of the plate 11. In the illustrated embodiment, the aperture 14 extends through the plate 11 at a constant edge, such that the diameter of the aperture 14 at the upper surface 12 is the same as the diameter of the aperture 14 at a lower surface of the plate 11. However, in other embodiments, the aperture 14 extends through the plate 11 at an angle, such that the diameter of the aperture 14 at the upper surface 12 is greater than the diameter of the aperture 14 at the lower surface of the plate 11.

In one embodiment, the upper surface 12 further comprises one or more additional aperture 23 having a perforated member 24 that removably secures within the additional aperture 23. In the shown embodiment, the perforated member 24 is configured to fit flush against the upper surface 12 when secured within the additional aperture 23, such that the perforated member 24 creates an even surface. A user can reach underneath the plate 11 to the lower surface and push upwards on the perforated member 24, thereby popping it out. However, in another embodiment, an outer perimeter of the perforated member 24 comprises a lip, such that when the perforated member 24 is secured within the aperture 23, the lip is raised at the upper surface 12. In this way, the lip allows a user to grip and remove the perforated member 24.

Referring now to FIG. 2, there is shown a perspective view of an embodiment of the lower surface of the plate attaching to the rod. The lower surface 17 of the plate is configured to secure to a first end 16 of a rod 15. The first end 16 of the rod 15 is configured to secure to a fastener 18 disposed on the lower surface 17 of the plate. In the illustrated embodiment, the fastener 18 comprises a protrusion on the lower surface 17 having an inner perimeter configured to slidably accept the first end 16, wherein the first end 16 comprises an indent configured to lock the rod 15 in place. In another embodiment, the fastener 18 is a button snap configured to release the plate 11 from the rod 15 when pressed. In one embodiment, the rod 15 is telescopic, such that it can move between an extended and retracted position, wherein a length of the rod 15 in the extended position is greater than the length of the rod 15 in the retracted position. In this way, a user can adjust the height of the rod 15 to allow for greater customization and ease of use while driving. Thereby, in one embodiment, the rod 15 is configured to have a height in the extended position such that the plate is aligned with the height of an arm rest.

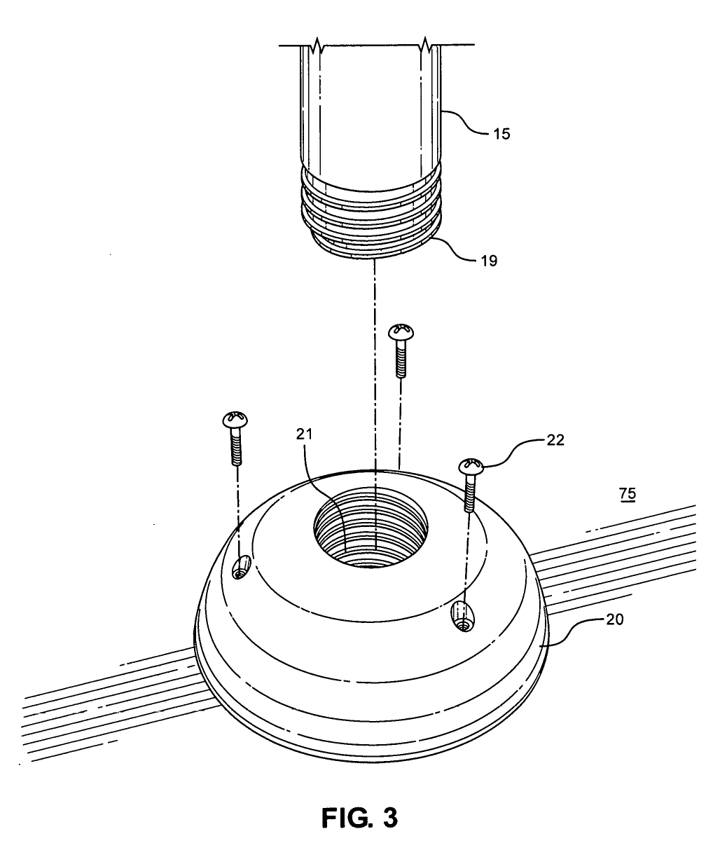

Referring now to FIG. 3, there is shown a perspective view of an embodiment of the rod attaching to the base when the base is attached to a surface. A second end 19 of the rod 15 is configured to secure to a base 20. A fastener 21 in the base 20 is configured to accept the second end 19, such that the rod 15 can be removably secured to the base 20. In the illustrated embodiment, the second end 19 is threaded such that it can screw into the fastener 21. In other embodiments, however, the second end 19 is configured to slidably secure into the fastener 21, or otherwise secure via a button snap, similar to the first end of the rod 15 securing to the plate.

The base 20 is configured to secure to a surface 75, such as the floor of an RV, via one or more fasteners 22. In the shown embodiment, the bottom side of the base 20 is planar, such that it can secure flush against the floor 75. In this embodiment, the base 20 is tapered such that the base 20 forms a pyramidal shape, wherein the rod 15 is provided additional support by the base 20. In the illustrated embodiment, the fasteners 22 comprises one or more screws to removably secure the base 20 to the floor 75, however in other embodiments the fastener 22 can comprise any suitably secure fastener, such as adhesive.

In operation, a user will set up the securable table assembly by placing the base on a surface, such as the floor of an RV, and removably securing the base to the surface via one or more fasteners. Once the base is securely attached, the user will insert the second end of the rod into the base and secure the rod to the base. The user will then secure the first end of the rod to the plate. Once the plate is securely fastened to the rod, the user can then utilize the one or more apertures in the plate to place a beverage container therein, or otherwise place food on the upper surface of the plate. In this way, a user can securely place their food and beverages on a plate while driving without concern the food or beverage will be spilled or lost.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A securable table assembly, comprising:
a plate, having a lower surface and an upper surface, wherein a sidewall extends along an outer perimeter of the upper surface thereby forming an interior volume with an open upper end;
one or more apertures disposed on the upper surface of the plate configured to receive a beverage container therein;
a rod, having a first end and a second end, wherein the first end of the rod removably secures to the lower surface of the plate via a fastener;
a base, having a top side configured to secure to the second end of the rod and a planar bottom side configured to secure flush against a surface via one or more fasteners.

2) The securable table assembly of claim 1, wherein the upper surface is planar.

3) The securable table assembly of claim 1, wherein the plate is annularly shaped.

4) The securable table assembly of claim 1, wherein the upper surface of the plate further comprises one or more perforated members that removably secure within one or more additional apertures.

5) The securable table assembly of claim 4, wherein an upper surface of each perforated member is flush with the upper surface of the plate when removably secured within the respective aperture.

6) The securable table assembly of claim 1, wherein the rod is telescopic.

7) The securable table assembly of claim 1, wherein a height of the rod comprises a length such that the plate is disposed at a height of an arm rest.
